(19) United States
(12) Patent Application Publication
(10) Pub. No.: US 2009/0214138 A1
(43) Pub. Date: Aug. 27, 2009

(54) IMAGE PROCESSING METHOD, AND PROCESSING METHODS FOR DIGITAL PHOTO FRAME AND INTERACTIVE IMAGE PROCESS

(75) Inventor: Yu Cheng Liao, Jhubei City (TW)

Correspondence Address: Muncy, Geissler, Olds & Lowe, PLLC, P.O. BOX 1364, FAIRFAX, VA, 22038-1364, US

(73) Assignee: Generalplus Technology Inc.

(21) Appl. No.: 12/120,111

(22) Filed: May 13, 2008

(30) Foreign Application Priority Data
Feb. 21, 2008 (TW) 097106000

(51) Int. Cl. G06K 9/60

(52) U.S. Cl. 382/305

(57) ABSTRACT

The invention relates to an image processing method, and processing methods for a digital photo frame and an interactive image process. The image processing method includes the steps of: providing an image; dividing the image into a plurality of blocks; and storing the blocks into a memory with the blocks respectively serving as a plurality of independent images.

This application claims priority of No. 097106000 filed in Taiwan R.O.C. on Feb. 21, 2008 under 35 USC 119, the entire content of which is hereby incorporated by reference.

### BACKGROUND OF THE INVENTION

1. Field of Invention

The invention relates to the image processing technology, and more particularly to an image processing method and methods for a digital photo frame and an interactive image process.

2. Related Art

In the digital age, digital images become more and more popularized in the daily life. A digital image is an image having digitized spatial coordinates and brightness. The digital image may be regarded as a two-dimensional matrix. Each column value and each row value define one point in the image, and its corresponding matrix element value is the color value of the pixel point. With the progress of the technology, methods for processing the digital images and digital image formats, including the JPEG (Joint Photographic Experts Group), have been developed.

FIG. 1 is a circuit block diagram showing a conventional digital photo frame. Referring to FIG. 1, the digital photo frame includes a storage device 11, a graphic decoding and scaling unit 12, a memory 13, a display engine 14 and a display panel 15. The graphic decoding and scaling unit 12 decodes and properly scales a designated picture stored in the storage device 11 according to an operation of a user, and then stores the decoded and scaled picture into the memory 13. The display engine 14 acquires and displays the decoded image stored in the memory 13 onto the display panel 15.

FIG. 2 is a circuit block diagram showing an interactive game apparatus. Referring to FIG. 2, the interactive game apparatus includes an image acquiring device 21, a memory 22, a display engine 23 and a display panel 24. The image acquiring device 21 is typically a small digital camera for capturing an image of the user or an image aimed by the user and storing the image into the memory 22. The display engine 23 acquires and displays the image stored in the memory 22 onto the display panel 24.

As mentioned hereinabove, the conventional image processing method is to either encode the acquired image into the format of the digital image and store the format of the digital image into the memory or to decode the digital image stored in the storage device 11 according to its format and then to display the decoded image onto a screen by the display engine. Because the above-mentioned image is stored as a whole image, the frame that can be displayed on the screen approaches the monotonic frame and does not have special variations. Even if the display engine can perform some special processes, the whole image has to be processed.

### SUMMARY OF THE INVENTION

In view of this, it is therefore an object of the invention to provide an image processing method and processing methods for a digital photo frame and an interactive image process in order to make the subsequent procedure for processing a single block of an image more easily and make complicated special effects be easily implemented.

To achieve the above-identified object or other objects, the invention provides an image processing method. The image processing method includes the steps of: providing an image; dividing the image into a plurality of blocks; and storing the blocks into a memory with the blocks respectively serving as a plurality of independent images.

The invention also provides an image processing method for a digital photo frame. The method includes the steps of: providing a storage medium; acquiring an image through the storage medium; dividing the image into a plurality of blocks; and storing the blocks into a memory with the blocks respectively serving as a plurality of independent images.

The invention further provides an interactive image processing method. The method includes the steps of: providing an image acquiring device; acquiring an image through the image acquiring device; dividing the image into a plurality of blocks; and storing the blocks into a memory with the blocks respectively serving as a plurality of independent images.

The image processing method according to the preferred embodiment of the invention further includes the step of providing a display engine for processing the independent images. In addition, the image in the image processing method for the digital photo frame according to one embodiment is a JPEG (Joint Photographic Experts Group) image, and the step of dividing the image into the plurality of blocks includes the sub-steps of: decoding the JPEG image to obtain a decoded image; and dividing the decoded image into a plurality of decoded block images.

The spirit of the invention is to divide the image into the plurality of blocks respectively serving as the plurality of independent images. Consequently, the game entertainment can be greatly enhanced. In addition, the image processing may have many variations without adding additional resources.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 is a circuit block diagram showing a conventional digital photo frame.

FIG. 2 is a circuit block diagram showing a conventional interactive game apparatus.

FIG. 3 is a flow chart showing an image processing method according to an embodiment of the invention.

FIG. 4 is a circuit block diagram showing the image processing method for a digital photo frame according to the embodiment of the invention.

FIG. 5 is a schematic illustration showing an interactive image processing method according to the embodiment of the invention.

FIGS. 6 to 8 are schematic illustrations showing image processing results according to the embodiment of the invention.

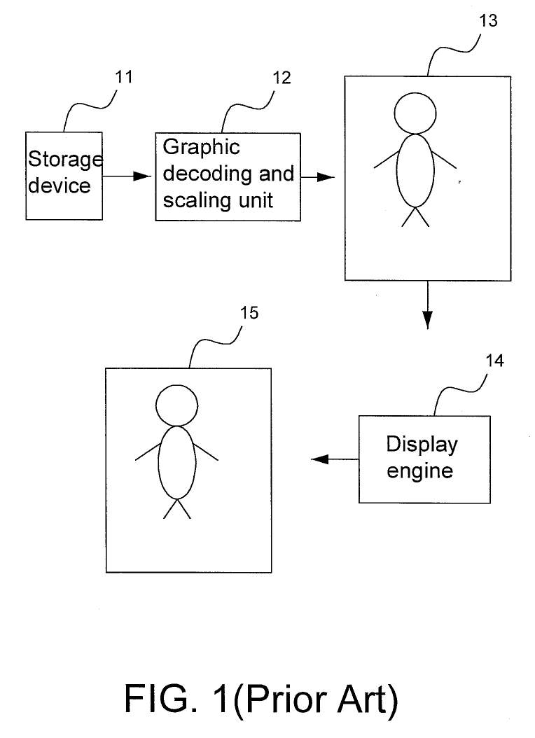

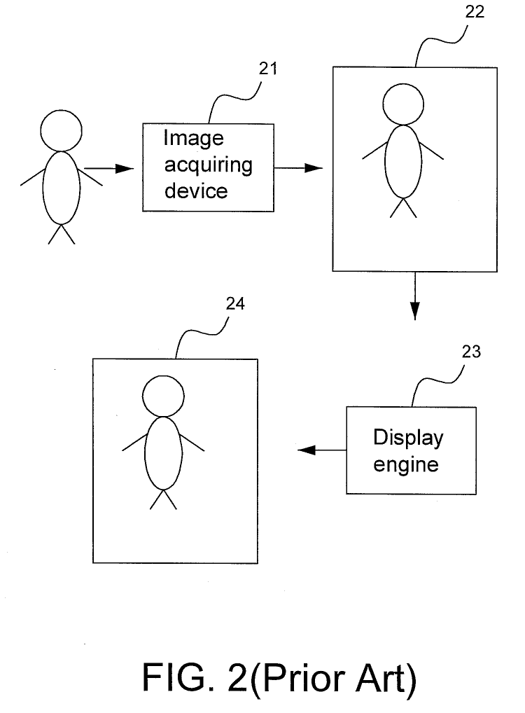

### DETAILED DESCRIPTION OF THE INVENTION

The present invention will be apparent from the following detailed description, which proceeds with reference to the accompanying drawings, wherein the same references relate to the same elements.

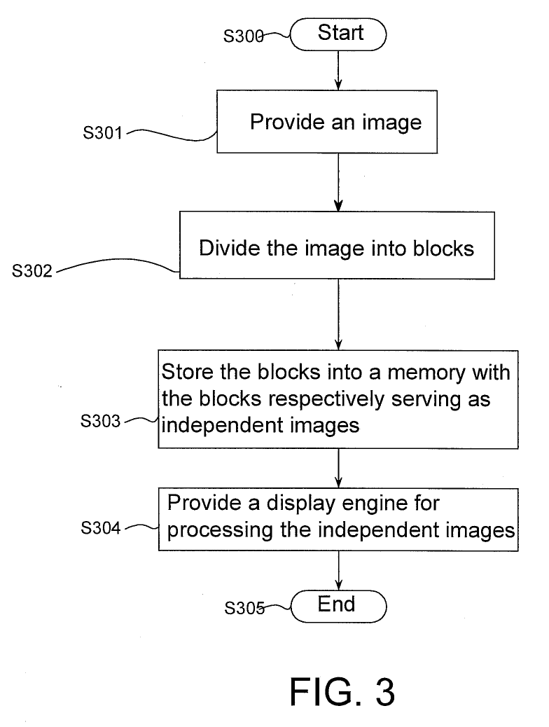

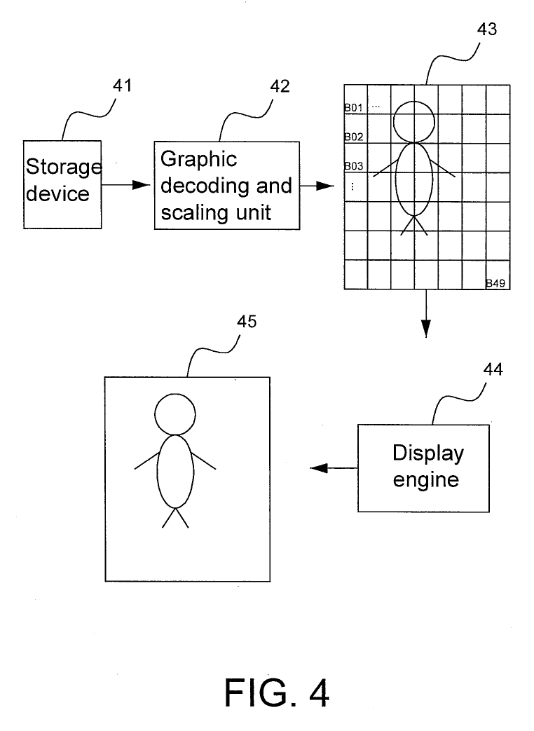

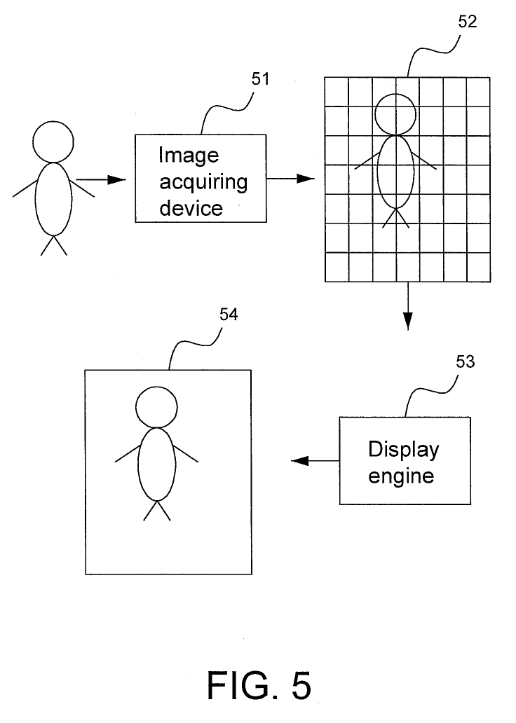

FIG. 3 is a flow chart showing an image processing method according to an embodiment of the invention. FIG. 4 is a circuit block diagram showing the image processing method for a digital photo frame according to the embodiment of the invention. FIG. 5 is a circuit block diagram showing an interactive image processing method for an interactive game apparatus according to the embodiment of the invention. Referring first to FIG. 4, the digital photo frame includes a storage device 41, a graphic decoding and scaling unit 42, a memory 43, a display engine 44 and a display panel 45. Referring next to FIG. 5, the interactive game apparatus includes an image acquiring device 51, a memory 52, a display engine 53 and a display panel 54. Referring to FIGS. 3 and 5, the image processing method includes the following steps.

In step S300, the method starts.

In step S301, an image is provided. For example, the image may be an image obtained by the graphic decoding and scaling unit 42, which decodes the JPEG file stored in the storage device 41 in FIG. 4, or may be an image acquired by the image acquiring device 51 in FIG. 5.

In step S302, the image is divided into a plurality of blocks.

In step S303, the blocks are stored into the memory with the blocks respectively serving as a plurality of independent images. Generally speaking, the image is stored into the memory according to the following conventional procedures. First, the first row of pixels is stored to the memory sequentially in the order from first to last pixels of the first row. Next, the second row of pixels is stored to the memory sequentially in the order from first to last pixels of the second row until the last pixel of the last row of pixels is stored. In this embodiment, the pixels are sequentially stored in the order from the first pixel of the first row of the first block B01 to the last pixel of the last row of the first block B01, and then from the first pixel of the first row of the second block B02 to the last pixel of the last row of the second block B02, and so on.

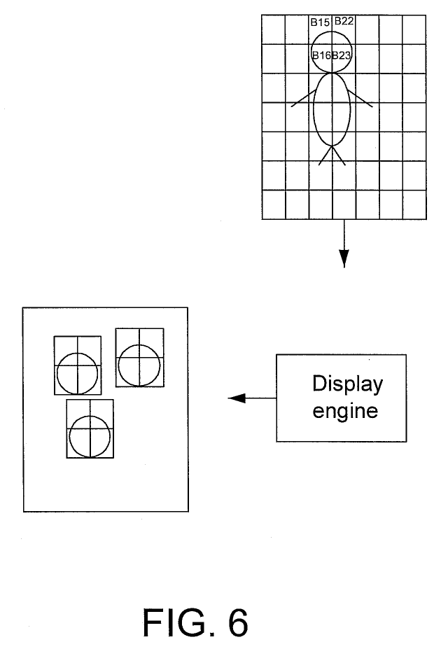

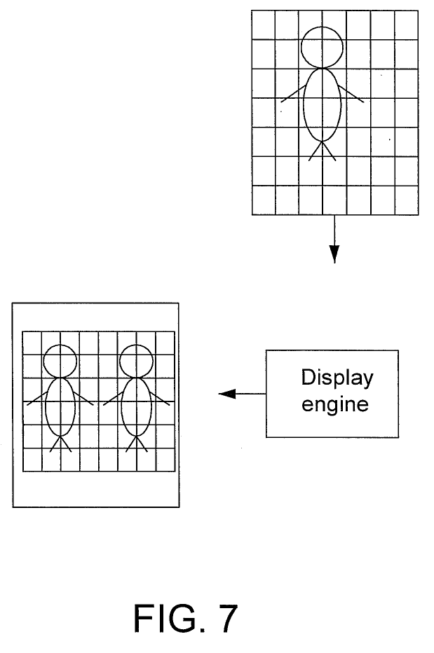

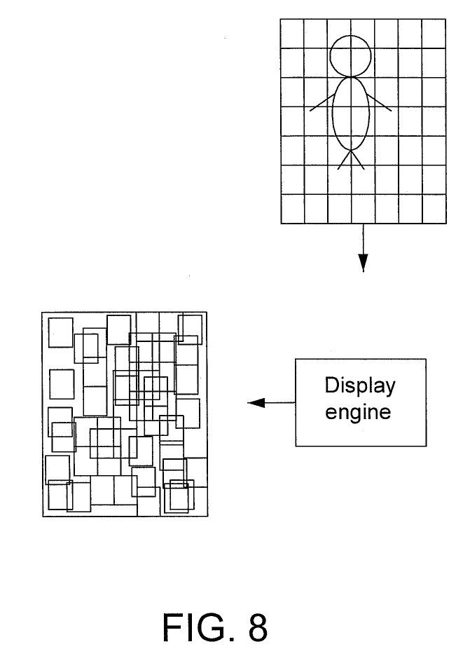

In step S304, a display engine is provided to process the independent images. FIGS. 6 to 8 are schematic illustrations showing image processing results according to the embodiment of the invention. As shown in the drawings, the display engines 44 and 53 can perform different processes on different blocks according to the user's operations or the parameters set by the user because the blocks in the memories 43 and 52 are separately stored. For example, the user can process the image blocks B15, B16, B22 and B23 with human heads, as shown in FIG. 6; display the blocks with human pictures on the display panel in parallel, as shown in FIG. 7; or display the blocks separately so that the user can play a puzzle game or the like, as shown in FIG. 8.

In step S305, the method ends.

In summary, the spirit of the invention is to divide the image into the blocks respectively serving as the independent images. Consequently, the game entertainment can be greatly enhanced, and the image processing may have variations without increasing the additional resources.

While the invention has been described by way of examples and in terms of preferred embodiments, it is to be understood that the invention is not limited thereto. To the contrary, it is intended to cover various modifications. Therefore, the scope of the appended claims should be accorded the broadest interpretation so as to encompass all such modifications.

What is claimed is:

1. An image processing method for a digital photo frame, the method comprising the steps of:
providing a storage medium;
acquiring an image through the storage medium;
dividing the image into a plurality of blocks; and
storing the blocks into a memory with the blocks respectively serving as a plurality of independent images.

2. The method according to claim 1, wherein the image is a JPEG (Joint Photographic Experts Group) image, and the step of dividing the image into the plurality of blocks comprises:
decoding the JPEG image to obtain a decoded image; and
dividing the decoded image into a plurality of decoded block images.

3. The method according to claim 1, further comprising the step of:
providing a display engine for processing the independent images.

4. An image processing method, comprising the steps of:
providing an image;
dividing the image into a plurality of blocks; and
storing the blocks into a memory with the blocks respectively serving as a plurality of independent images.

5. The method according to claim 4, further comprising the step of:
providing a display engine for processing the independent images.

6. An interactive image processing method, comprising the steps of:
providing an image acquiring device;
acquiring an image through the image acquiring device;
dividing the image into a plurality of blocks; and
storing the blocks into a memory with the blocks respectively serving as a plurality of independent images.

7. The method according to claim 6, further comprising the step of:
providing a display engine for processing the independent images.
